(19) United States
(12) Patent Application Publication
(10) Pub. No.: US 2026/0324584 A1
(43) Pub. Date: Oct. 22, 2026

(54) ANIMAL CLEANUP MACHINE AND ASSOCIATED METHODS

(71) Applicant: Longhopes Donkey Shelter, Inc., Bennett, CO (US)

(72) Inventor: Kathy E. Dean, Bennett, CO (US)

(21) Appl. No.: 19/641,040

(22) Filed: Apr. 7, 2026

Related U.S. Application Data
(60) Provisional application No. 63/792,098, filed on Apr. 21, 2025.

(51) Int. Cl. A01K 1/01; G05D 1/227; G05D 1/229; G05D 1/248; G05D 1/622; G05D 1/689; G05D 1/86; G05D 105/50; G05D 107/20; G05D 109/10; G05D 111/10

(52) U.S. Cl. CPC A01K 1/0146; G05D 1/2272; G05D 1/229; G05D 1/248; G05D 1/622; G05D 1/6895; G05D 1/86; G05D 2105/50; G05D 2107/21; G05D 2109/10; G05D 2111/17

(57) ABSTRACT

An autonomous animal cleanup machine is configured to identify, collect, and transport animal manure within an outdoor animal enclosure. The machine includes a mobile chassis with a drive train, a maneuverable arm supporting a manure collection implement, a camera, a global navigation satellite system (GNSS) receiver, and a controller with embedded artificial intelligence processing. The controller processes images captured by the camera using a computer vision model to detect animal manure and determines a georeferenced location of the detected manure based on image‑plane data, GNSS‑derived position data, orientation data, and range information. The controller autonomously navigates the machine to the manure location, actuates the maneuverable arm to collect the manure, and transports the collected manure to a predefined deposit location. Detected manure locations may be stored as waypoints and serviced according to a coverage or scheduling strategy, enabling efficient and safe operation within dynamic outdoor environments.

### CROSS-REFERENCE TO RELATED APPLICATION

This application claims priority to US Patent Application Serial Number 63/792,098, titled “Animal Cleanup Machine and Associated Methods,” filed Apr. 21, 2025, which is incorporated herein by reference in its entirety.

### BACKGROUND

Maintaining outdoor animal enclosures requires periodic removal of animal manure to support sanitation and animal health, yet performing such tasks in paddocks and similar environments presents practical difficulties. These environments are often irregularly bounded, subject to changing ground conditions and lighting, and may include animals, people, and miscellaneous objects that complicate automated operation. Accurately identifying animal manure within such environments, determining its location relative to a mobile platform, and safely navigating to collect and dispose of the manure without disrupting animals or personnel pose nontrivial technical challenges. In addition, reliable operation may require the ability to function under variable environmental conditions while maintaining predictable and controllable behavior.

### SUMMARY

There is a need for improved machines and methods that address the challenges described above by enabling autonomous identification, localization, collection, and disposal of animal manure within outdoor animal enclosures.

An autonomous robot is designed and manufactured for cleaning up manure in a paddock at a donkey shelter. In certain embodiments, the robot stores detected manure locations as georeferenced “pins” (waypoints) in memory and schedules retrieval of the manure based on the stored pins, a current robot pose, and a coverage plan for the paddock. The robot may determine a manure geolocation by combining (i) an image‑plane location of the manure within an RGB image, (ii) a robot pose including a current location from a locating device (e.g., a global navigation satellite system (GNSS) receiver) and an orientation estimate, and (iii) a range estimate to the manure derived from a LiDAR point cloud, stereo disparity, monocular depth inference, or a ground‑plane projection calibrated to the camera mounting geometry. In certain embodiments, the robot defines a paddock boundary and one or more manure deposit locations using location measurements collected during a manual “teaching” phase, including by operating the locating device in a differential mode using a base station to improve boundary accuracy.

One aspect of the present embodiments includes the realization that it is important for the robot to be able to discern between manure and other objects in the paddock, such as donkey toys. The present embodiments solve this problem by using computer vision algorithms implemented by embedded AI hardware in the robot to process images from a camera, detect manure in the image, and determine a location of the manure in the paddock. The robot is configured to scoop up the manure and move it to a defined manure deposit location in the paddock.

In certain embodiments, the techniques described herein relate to an animal cleanup machine, including: a mobile chassis including a drive train configured to move the machine within an animal enclosure; a maneuverable arm supported by the chassis and having a manure collection implement; a camera configured to capture images of an environment ahead of the machine; a locating device configured to determine a current location of the machine; a controller including at least one processor and memory storing machine-readable instructions, the controller configured to: process the images using a computer vision model to detect animal manure within the images; determine a georeferenced location of the detected animal manure based on (i) an image-plane location of the detected animal manure, (ii) the current location from the locating device, and (iii) an orientation estimate of the machine; control the drive train to position the machine at the georeferenced location of the detected animal manure; and control the maneuverable arm to collect the detected animal manure and transport the collected animal manure to a predefined manure deposit location within the enclosure.

In certain embodiments, the techniques described herein relate to a method of autonomously collecting animal manure, including: capturing images of an outdoor animal enclosure using a camera mounted on a mobile animal cleanup machine; processing the images using a computer vision model executed by a controller of the machine to detect animal manure; determining a georeferenced location of the detected animal manure based on the images, a location of the machine, and an orientation of the machine; controlling a drive train of the machine to move the machine to the georeferenced location; actuating a maneuverable arm to collect the detected animal manure; and transporting the collected animal manure to a predefined manure deposit location.

In certain embodiments, the techniques described herein relate to a non-transitory computer-readable medium storing instructions that, when executed by one or more processors of a mobile robotic animal cleanup machine, cause the mobile robotic animal cleanup machine to: process image data from a camera using a trained vision model to detect animal manure; determine a georeferenced manure location using the detected animal manure, position data, orientation data, and range data from a ranging sensor; control a drive train to navigate to the georeferenced manure location; control a maneuverable arm to collect the animal manure; and control the drive train and maneuverable arm to transport and deposit the animal manure at a predefined deposit location.

### BRIEF DESCRIPTION OF THE FIGURES

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a perspective view illustrating one example animal cleanup machine, in embodiments.

FIG. 2 is a block diagram illustrating the animal cleanup machine of FIG. 1 in further example detail.

FIG. 3 is a high-level schematic illustrating the controller of FIG. 2 in further example detail, in embodiments.

FIG. 4 is a block diagram illustrating the computer vision algorithm of FIG. 3 in further example detail, in embodiments.

FIG. 5 is a perspective view of the chassis of FIG. 1 in further example detail, in embodiments.

FIG. 6 is a perspective view of the chassis of FIG. 5 fitted with a top plate and handles, in embodiments.

FIG. 7 is a perspective view illustrating the drive train of FIG. 1 in further example detail, in embodiments.

FIG. 8 is a perspective view illustrating an arm mechanism that includes the maneuverable arm and the shovel of FIG. 1 with a CAM component, in embodiments.

FIG. 9 is a perspective view illustrating one example rechargeable battery of FIG. 2, in embodiments.

FIG. 10 is a perspective view illustrating one example power box for containing a rechargeable battery of FIGS. 2 and 9.

FIG. 11 is a perspective view illustrating one example GNSS base station that may be configured within environment to allow GNSS receiver to operate in a differential mode that is more accurate than operation without GNSS base station.

FIG. 12 is a perspective view illustrating one example of the LiDAR of FIGS. 1 and 2, in embodiments.

FIG. 13 is a perspective view illustrating one example of the camera of FIGS. 1 and 2, in embodiments.

FIG. 14 is an image showing one example NVIDIA Jetson AGX Orin circuit board for implementing the controller of FIG. 2, in embodiments.

FIG. 15 is a flowchart illustrating one example method for controlling an animal cleanup machine to clean up manure in an environment, in embodiments.

FIG. 16 is a wiring schematic illustrating one example manual override switching arrangement using a multi‑channel relay to selectively couple either the controller or a handheld radio controller to the drive train electronic speed controller and steering controller, in embodiments.

FIG. 17 is a wiring schematic illustrating one example arm motor direction control and limit switch feedback, in embodiments.

FIG. 18 is a schematic illustrating one example signal light driver using a relay and controller GPIO/PWM outputs to present different status sequences, in embodiments.

FIG. 19 is a block diagram illustrating one example coordinate‑frame transformation pipeline for converting image detections into georeferenced manure waypoints, in embodiments.

FIGS. 20A and 20B illustrate one example embodiment of an animal cleanup machine that implements differential steering using two traction motors, in embodiments.

### DETAILED DESCRIPTION OF THE EMBODIMENTS

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one implementation” or “an implementation” or “one embodiment” or “an embodiment” means that a particular feature, structure or characteristic described in connection with the embodiment is included in at least one implementation or embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

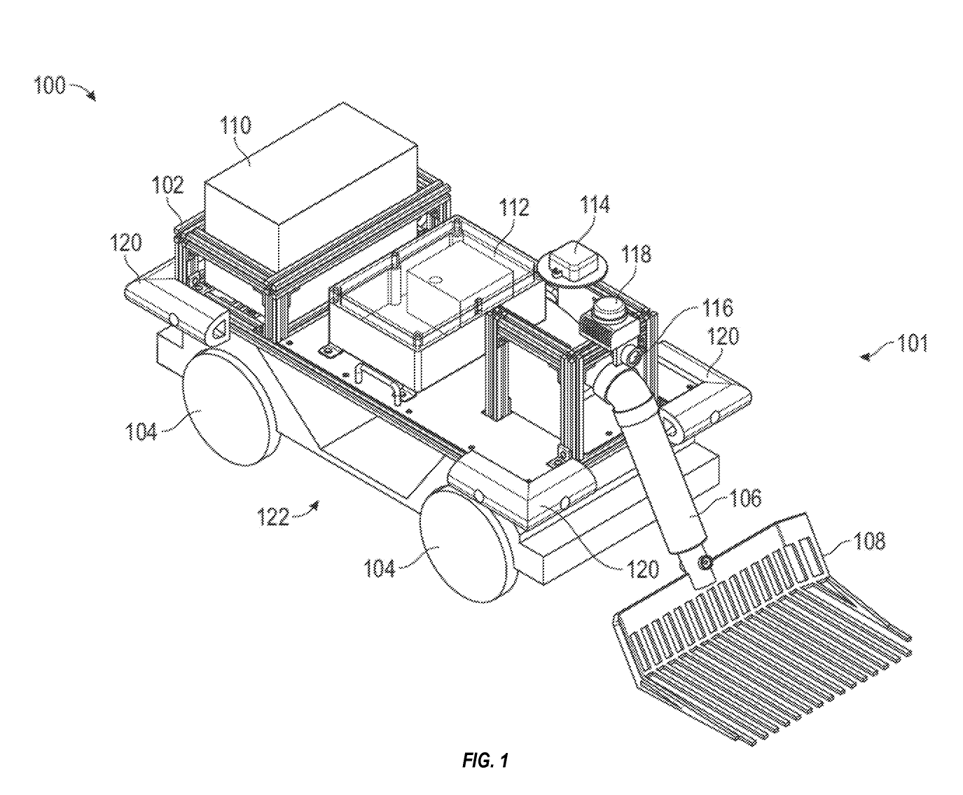

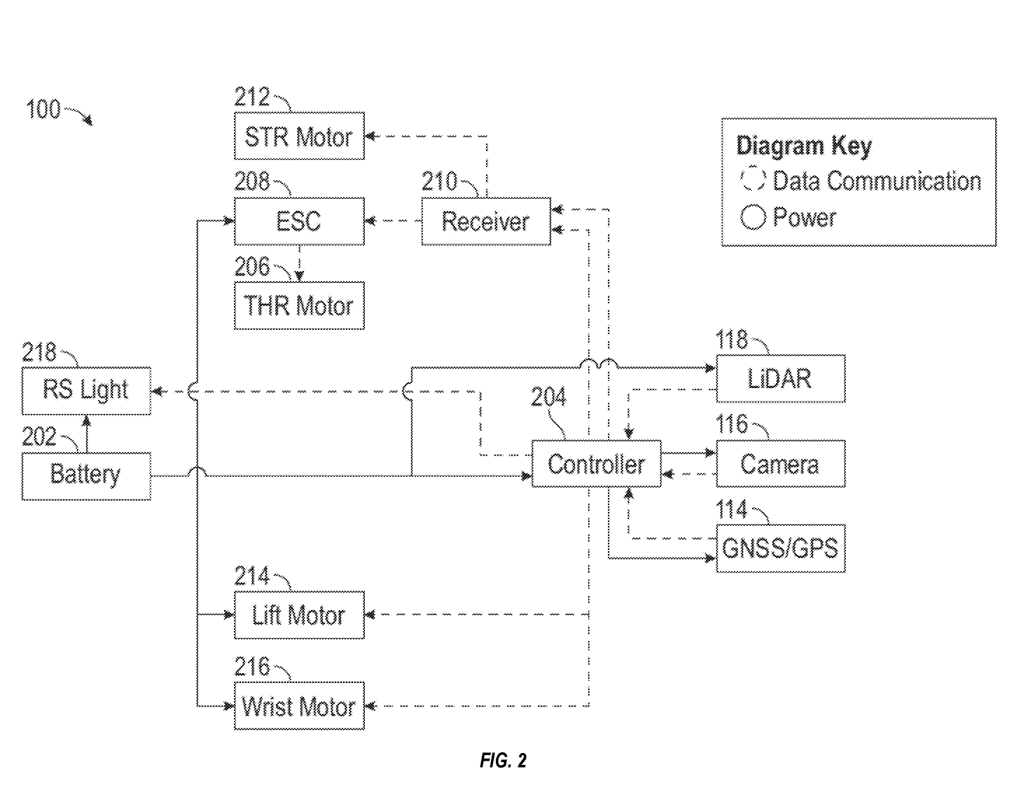

FIG. 1 is a perspective view illustrating one example animal cleanup machine 100, in embodiments. FIG. 2 is a block diagram illustrating animal cleanup machine 100 of FIG. 1 in further example detail. Particularly, FIG. 2 shows how power and control signals are distributed throughout animal cleanup machine 100. FIGS. 1 and 2 are best viewed together with the following description. Animal cleanup machine 100 addresses the challenge of efficiently cleaning a paddock used by animals, where current manual processes are both time consuming and labor intensive. Animal cleanup machine 100 autonomously navigates a paddock, collects manure, and transports the manure to a designated dumping area.

In certain embodiments, the environment is an outdoor paddock with a predefined boundary (e.g., a fence line) represented in memory as a closed polygon in a geodetic or local tangent plane coordinate system. The controller may enforce boundary compliance by continuously comparing a current robot pose to the boundary polygon and generating steering and traction commands to maintain the robot within the boundary while executing a coverage plan.

Animal cleanup machine 100 includes a chassis 102 mounted on a drive train 122 that includes four wheels 104. Chassis 102 provides mechanical support for a maneuverable arm 106 with a manure collection implement 108 (e.g., a shovel or fork like scooper) positioned at a front of animal cleanup machine 100, a power box 110 for housing a rechargeable battery 202, and a weatherproof control box 112 for housing a controller 204 and certain other electronic components and circuitry of animal cleanup machine 100. In certain embodiments, manure collection implement 108 is a rake or rake‑like attachment that is removably coupled to maneuverable arm 106 to permit replacement due to wear or to permit use of different manure‑collection attachments. Controller 204 is for example an NVIDIA Orin Jetson or similar computer. Animal cleanup machine 100 also includes a locating device such as a global navigation satellite system (GNSS) receiver 114 (e.g., a GPS receiver) positioned to receive satellite signals and determine a current location of animal cleanup machine 100, a camera 116 positioned at the front of animal cleanup machine 100 with a forward facing field-of-view (FOV), and a LiDAR 118 positioned at the front of animal cleanup machine 100 with a 360° FOV. In certain embodiments, animal cleanup machine included additional processors, such as an Arduino or Latte Panda for processing GNSS signals. At least two wheels 104 are driven by a traction motor 206 that is driven by an electronic speed controller (ESC) 208 based on instructions received from controller 204 via a receiver 210. Front wheels 104 are steered by a steering motor 212 that is controlled by controller 204 via receiver 210. Maneuverable arm 106 includes a lift motor 214 that raises and lowers maneuverable arm 106, and a wrist motor 216 for rotating manure collection implement 108. Lift motor 214 and wrist motor 216 are controlled by controller 204. Animal cleanup machine 100 may also include a robot signal light 218 that is controlled by controller 204 to provide an indication of operation of animal cleanup machine 100 and/or an operational status. In certain embodiments, animal cleanup machine 100 has overall dimensions on the order of about 30 inches by about 30 inches by about 20 inches (L×W×H) and a ground clearance on the order of about 3 inches. In certain embodiments, unloaded mass is less than about 50 pounds and loaded mass is on the order of about 75pounds including a battery and collected manure. In certain embodiments, enclosures for electronics meet at least an IP‑65 environmental protection rating and are configured for operation in ambient temperatures between about 32°F and about 100°F.

Rechargeable battery 202 provides electrical power to LiDAR 118, controller 204, ESC 208, lift motor 214, wrist motor 216, and robot signal light 218. Controller 204 generates control signals to control one or more of ESC 208 and steering motor 212 via receiver 210, lift motor 214 and wrist motor 216 to control operation of maneuverable arm 106 and manure collection implement 108, and robot signal light 218. Controller 204 receives input from GNSS receiver 114, camera 116, and LiDAR 118. Controller 204 includes software with machine-readable instructions, executable by a processor of controller 204, to cause controller 204 to control behavior of animal cleanup machine 100 based on an environment 101 sensed by controller 204.

In certain embodiments, animal cleanup machine 100 also includes bumpers 120 positioned at corners of chassis 102 to protect against damage from collision with unexpected objects in environment 101. In certain embodiments, moving joints and rotating members are covered by guards to reduce pinch hazards, and electrical enclosures are tested for water ingress by spray and submersion screening prior to field deployment.

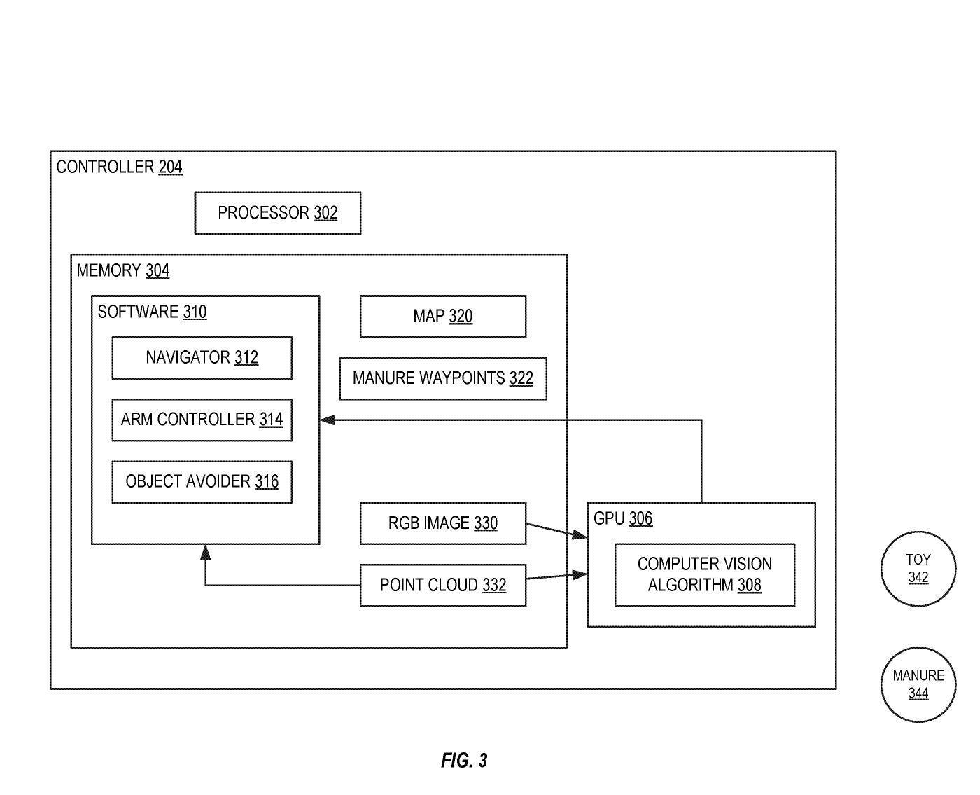

FIG. 3 is a high-level schematic illustrating controller 204 of FIG. 2 in further example detail, in embodiments. Controller 204 includes a processor 302, memory 304, and a graphics processing unit (GPU) 306. Memory 304 stores software 310 that includes machine-readable instructions that are executable by processor 302 to implement a plurality of algorithms that control operation of animal cleanup machine 100 as described herein. Software 310 includes a navigator 312 that controls navigational movement of animal cleanup machine 100, an arm controller 314 that controls movement of maneuverable arm 106 and manure collection implement 108, and an object avoider 316 that detects objects within environment 101 and cooperates with navigator 312 to prevent animal cleanup machine 100 from colliding with detected objects. In certain embodiments software 310 may include algorithms that process one or both of RGB image 330 and point cloud 332 to generate or enhance a map 320 that defines the location of structure and/or movable objects within environment 101 when encountered by animal cleanup machine 100. Map 320 may include (i) a boundary polygon, (ii) georeferenced locations of static obstacles, (iii) georeferenced “manure waypoint” locations generated from detections, and (iv) one or more exclusion zones around hazards or areas not to be traversed. Controller 204 may update map 320 using LiDAR‑derived obstacle detections and/or GNSS‑recorded landmarks acquired during a manual teaching phase.

Navigator 312 also implements a pathfinding algorithm that controls animal cleanup machine 100 to traverse environment 101 (e.g., the animal paddock). In one example of operation, navigator 312 (e.g., the pathfinding algorithm) dynamically considers a current location (e.g., determined by GNSS receiver 114) of animal cleanup machine 100, the static boundaries of environment 101 (e.g., defined as location coordinates captured by GNSS receiver 114), the location coordinates of static obstacles within environment 101 (e.g., trees, water spigot, shelter, etc.) and any dynamic obstacles identified by LiDAR 118. Accordingly, animal cleanup machine 100 may autonomously traverse environment 101 within defined boundaries while avoiding obstacles. For example, a goal of animal cleanup machine 100 is to have 95% traversal coverage of environment 101 during a cleaning session. In certain embodiments, navigator 312 executes a coverage path (e.g., a path that covers environment 101) until computer vision algorithm 308 generates a manure detection; the controller then records a manure location and either immediately diverts to collect the manure or queues the location (e.g., as a waypoint) for later collection according to a scheduling policy (e.g., nearest‑neighbor, prioritized by age, or prioritized by estimated size). After collection, navigator 312 routes animal cleanup machine 100 to a predefined manure deposit location (e.g., within environment 101) and then resumes coverage or proceeds to a next queued manure location.

In certain embodiments, controller 204 determines a robot pose (e.g., location and orientation of animal cleanup machine 100) using sensor fusion of measurements from multiple sensors. For example, controller 204 may estimate location using GNSS receiver 114 and may estimate orientation and/or short term motion using one or more of (i) an inertial measurement unit (IMU) that outputs acceleration and angular rate, and (ii) wheel or motor encoders that output rotation measurements corresponding to wheel travel. In one example, controller 204 combines GNSS measurements, IMU measurements, and encoder measurements in a filtering framework (e.g., a Kalman filter, extended Kalman filter, particle filter, or factor graph optimization) to determine a pose estimate used for navigation, boundary enforcement, and transformation of manure detections into georeferenced locations.

In certain embodiments, animal cleanup machine 100 includes a hardware fail‑safe configured to place one or more motors (e.g., motors 212, 214, and 216) in a safe state in response to a fault condition. For example, controller 204 is communicatively coupled to one or more motor controllers that drive traction motor 206, lift motor 214, and/or wrist motor 216, and controller 204 includes an output line (e.g., a GPIO line) coupled to a motor‑controller enable input, inhibit input, or emergency stop input. When controller 204 detects a fault condition, such as loss of communication with a motor controller, watchdog timeout, or software exception, controller 204 asserts the output line to disable motor actuation, thereby reducing risk of unintended motion. In certain embodiments, the fail‑safe operates independently of a user‑actuated emergency stop button and independently of a manual override mode, providing redundant safety behavior during autonomous or tele‑operated operation.

GPU 306 is configured to implement a computer vision algorithm 308 (e.g., a vision language model (VLM), an image classifier, a transformer, or other type of neural network) that processes one or both of an RGB image 330 from camera 116 and/or a point cloud 332 captured by LiDAR 118 to identify certain objects within the images. For example, computer vision algorithm 308 may determine whether or not RGB image 330 contains manure 344. Accordingly, computer vision algorithm 308 discerns between manure and other objects found within environment 101. Computer vision algorithm 308 may also indicate a location of the identified toy 342 and/or manure 344 within the image and/or within the environment based on a current location and orientation of animal cleanup machine 100. In one example of operation, the controller determines an image‑plane bounding box for manure in the RGB image, selects a corresponding LiDAR subset in a calibrated sensor frame, estimates a 3D position of the manure relative to the robot, and transforms that 3D position into an earth‑fixed or local map frame using the current robot pose from the GNSS receiver and an orientation estimate derived from a GNSS heading solution, an inertial measurement unit, wheel odometry, or a fusion thereof.

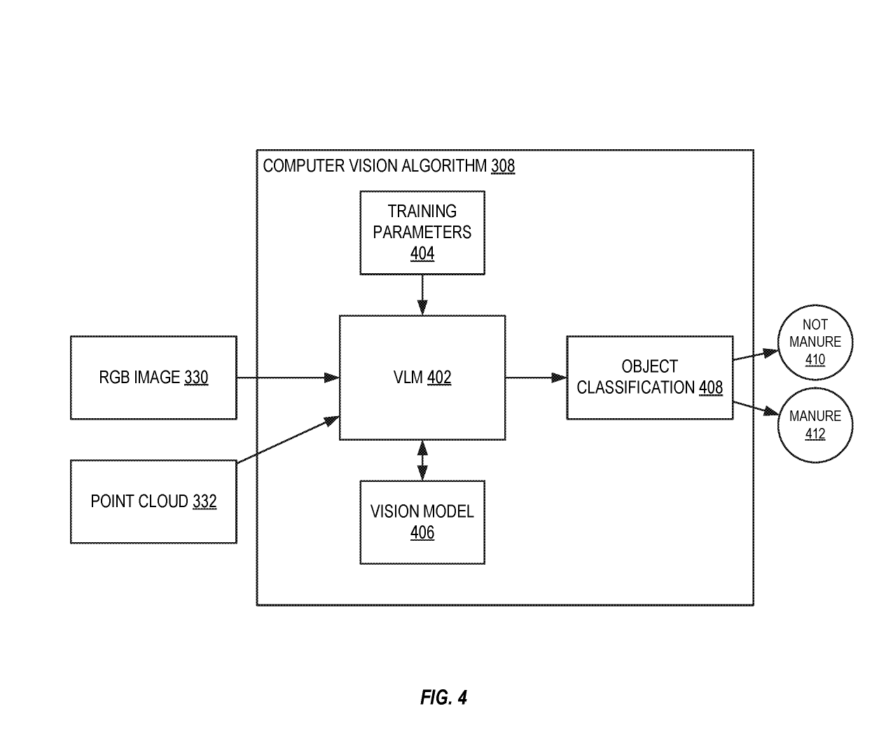

FIG. 4 is a block diagram illustrating computer vision algorithm 308 of FIG. 3 in further example detail, in embodiments. Computer vision algorithm 308 implements a VLM 402 that is trained, using training parameters 404 to implement a vision model 406 for generating an object classification 408 for objects captured within RGB image 330 and/or point cloud 332. Object classification 408 classifies RGB image 330 as being one of not manure 410 and manure 412, for example. Vision model 406 may be trained to identify other object within environment 101 without departing from the scope hereof. For example, vision model 406 may be trained to identify a donkey and/or a person to aid in obstacle avoidance. Training parameters 404 may include dataset composition parameters that include images of animal manure under different lighting and ground conditions and images of non‑manure distractors including toys 342 and natural debris. Vision model 406 may be validated by field testing in which toys 342 and manure look‑alikes are placed in view and the model is evaluated for false positives and false negatives.

### Chassis Concepts

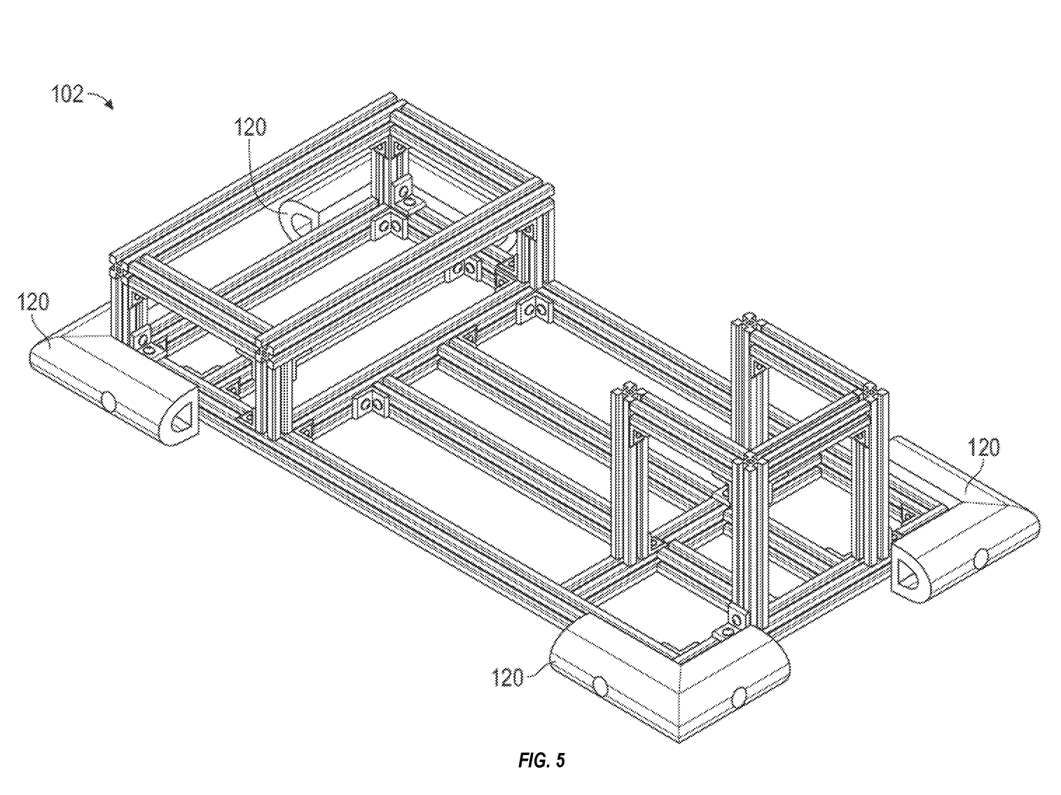

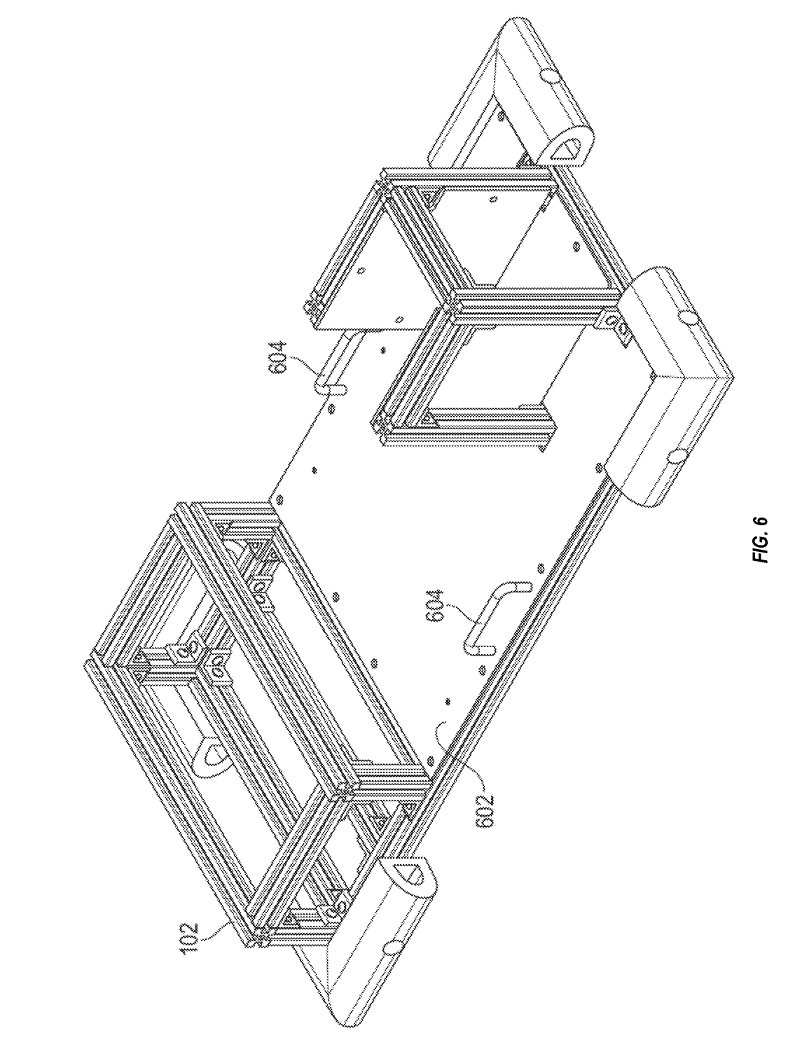

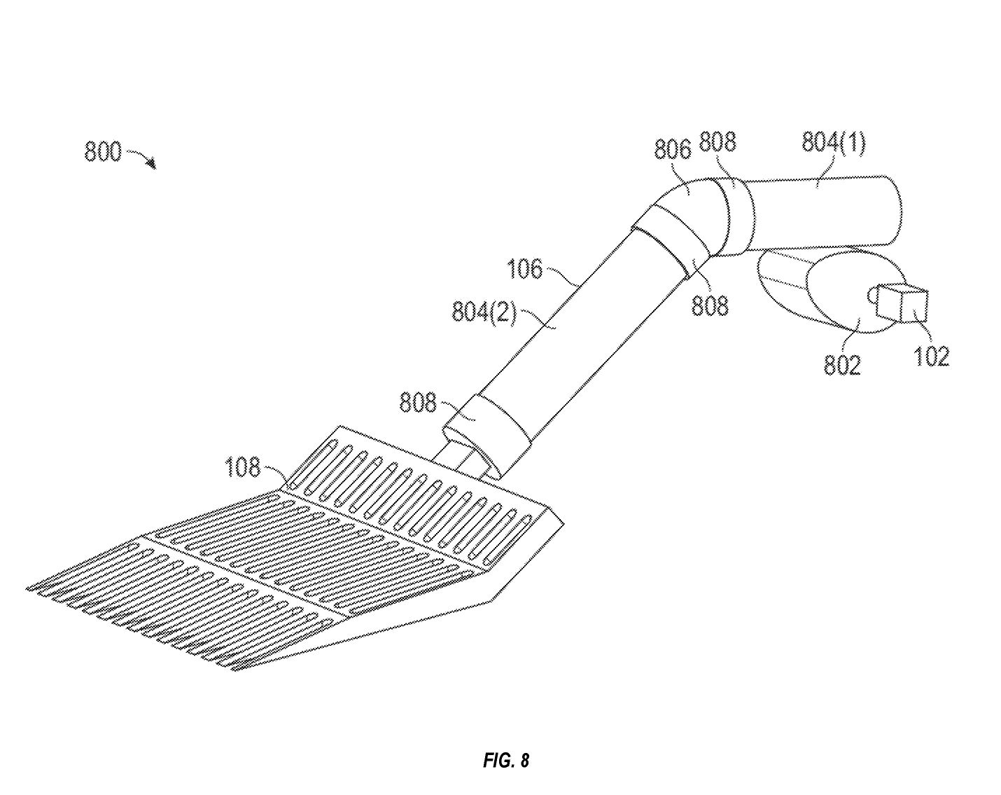

FIG. 5 is a perspective view of chassis 102 of FIG. 1 in further example detail, in embodiments. FIG. 6 is a perspective view of chassis 102 of FIG. 5 fitted with a top plate 602 and handles 604, in embodiments. Chassis 102 provides support for other components of animal cleanup machine 100. Chassis 102 provides structure and stability for the electrical and mechanical components of animal cleanup machine 100. Chassis 102 is lightweight, sturdy and modular and is selected to keep the overall weight of animal cleanup machine 100 to a minimum. Further, the use of standard components within drive train 122 facilitates replacement of components without specialized tooling or proprietary fixtures. Chassis 102 has a T-slotted aluminum extrusion frame that with compatible fasteners/connectors/brackets facilitate attachment of other components easily and retains those components in place. Advantageously, the use of modular components in chassis 102 allows parts to be easily adjusted and/or replaced due to wear and tear without the need for welding or drilling of holes. Top plate 602 facilitates attachment of other components of animal cleanup machine 100 and handles 604 allow easy carrying of animal cleanup machine 100. At the front of animal cleanup machine 100 chassis 102 also provides support for a CAM component (e.g., see CAM components 802 of FIG. 8) of maneuverable arm 106. In certain embodiments, chassis 102 includes aluminum mounting plates configured to secure the arm CAM component and to provide attachment points for the control box and power box, and includes one or more handles configured to permit a single person to lift and carry animal cleanup machine 100 for storage or redeployment.

### Drive Train Concepts

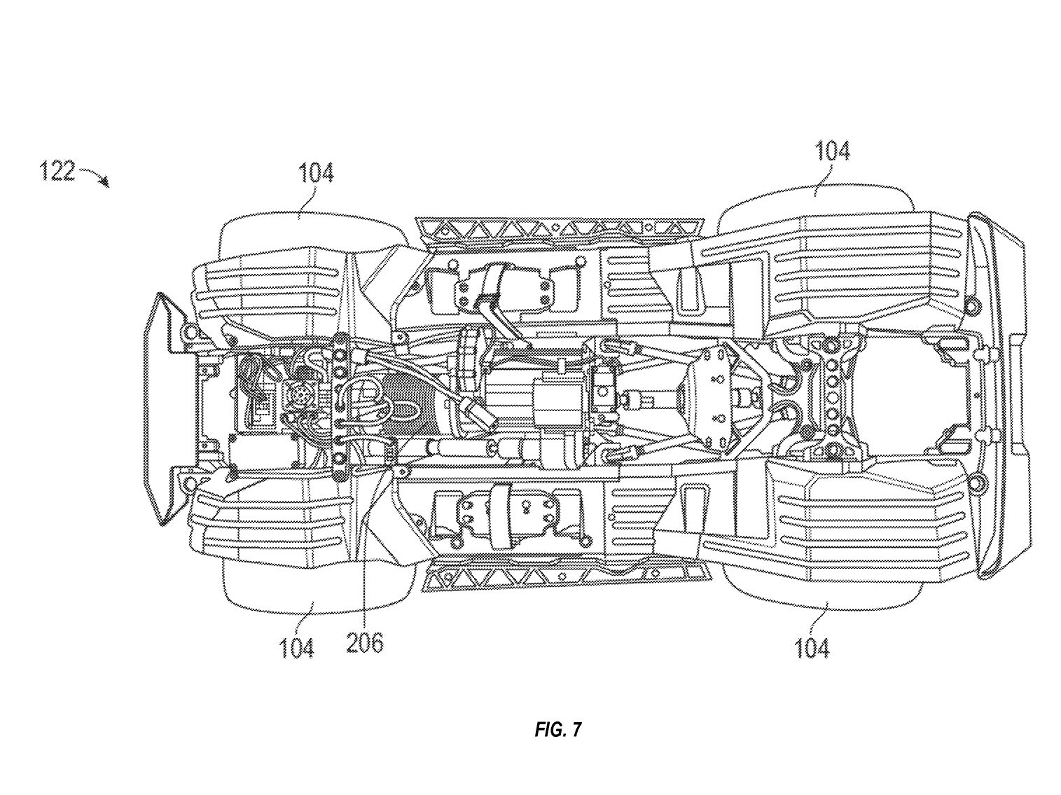

FIG. 7 is a perspective view illustrating drive train 122 of FIG. 1 in further example detail, in embodiments. In certain embodiments, drive train 122 is a prebuilt radio control drive train that is adapted for use as animal cleanup machine 100. Drive train 122 is sufficiently rugged and durable to traverse an animal paddock and sufficiently maneuverable to position animal cleanup machine 100 in front of manure and to transfer the manure to one or more manure deposit locations within environment 101. Drive train 122 is selected to support the overall weight of animal cleanup machine 100 and includes an emergency stop button, a manual override, basic waterproofing for traction motor 206 and steering motor 212, and has few to no pinch points in its design. Drive train 122 has an emergency stop located on a bottom surface and allows use of a remote controller for manual control of animal cleanup machine 100. Drive train 122 includes a plastic cover positioned below traction motor 206 and steering motor 212 to prevent undercarriage splashes from reaching the motors. Further, top plate 602 prevents rainfall from reaching traction motor 206 and steering motor 212.

In certain embodiments, animal cleanup machine 100 includes a manual override subsystem configured to selectively switch control of at least steering and traction between (i) the embedded controller and (ii) a handheld radio control transmitter/receiver pair. In one example, a multi‑channel relay selectively couples PWM/control lines so that the drive train electronic speed controller and steering controller receive commands from either controller 204 or the radio receiver 210. The relay may be actuated by a physical switch, a keyed switch, or a controller‑commanded fail‑safe state, thereby allowing immediate manual recovery when autonomous behavior is degraded.

In certain embodiments, drive train 122 is configured as a differential drive in which left and right drive wheels are independently powered by respective traction motors, and steering is achieved by differentially controlling the speeds and/or directions of the traction motors. In such embodiments, controller 204 may command the traction motors to rotate in opposite directions to produce a zero‑radius (turn‑in‑place) maneuver that rotates animal cleanup machine 100 about a vertical axis with a minimal footprint, thereby improving maneuverability in confined areas and enabling reorientation without requiring a large turning radius. In certain embodiments, controller 204 controls the differential drive via one or more motor controllers that regulate motor speed and direction based on commanded velocity setpoints, including, for example, commanded linear and angular velocities.

### Arm Design Concepts

FIG. 8 is a perspective view illustrating an arm mechanism 800 that includes maneuverable arm 106 and manure collection implement 108 of FIG. 1 with a CAM component 802, in embodiments. CAM component 802 is a tear drop shaped part that is rotated by lift motor 214 to raise and lower maneuverable arm 106, which is hinged at an upper end for example. Arm mechanism 800 is controlled to procure animal manure scattered around environment 101 and to deposit the animal manure in one or more designated locations of environment 101. Arm mechanism 800 is designed to withstand a 15-pound load that includes the collective weight of maneuverable arm 106, wrist motor 216, manure collection implement 108, and the animal manure being transported by animal cleanup machine 100. Wrist motor 216 is controlled to rotate manure collection implement 108 from a horizontal position as shown to a vertical position that causes the transported manure to drop when animal cleanup machine 100 is located at one or the designated manure deposit locations. In certain embodiments, the lift motor and/or wrist motor are controlled with position limits enforced by limit switches arranged in series with the motor drive so that, upon overshoot or loss of control, the switch interrupts motor power and provides a feedback signal to controller 204 indicative of a limit condition. In certain embodiments, maneuverable arm 106 is configured to lift manure collection implement 108 to a height on the order of about 8 inches above ground to clear manure and permit transport prior to dumping.

In certain embodiments, maneuverable arm 106 is formed of two PVC pipes 804(1) and 804(2), a 45-degree PVC elbow 806, and PVC connectors 808. Manure collection implement 108 is for example a fork normally used manually that is adapted for use with animal cleanup machine 100. In certain embodiments, PVC piping 804 has a two-inch diameter; however, other sizes may be used without departing from the scope hereof. Wrist motor 216 may be positioned within PVC pipe 804(2) close to manure collection implement 108. Wrist motor 216 may couple with manure collection implement 108 by a half-inch PVC pipe that produces a degree of freedom for rotation of manure collection implement 108 by wrist motor 216. CAM component 802 is positioned beneath PVC pipe 804(1), is attached to lift motor 214, and is held in place by two mounting plates on chassis 102. Lift motor 214 and wrist motor 216 may each comprise a geared DC motor (e.g., a planetary gear motor) or a high‑torque servo. In one non‑limiting example, each motor provides an output speed on the order of about 23 rpm and a stall torque sufficient to exceed expected static and dynamic torque loads by at least about 20%.

In certain embodiments, maneuverable arm 106 and/or rotatable manure collection implement 108 includes one or more reference sensors configured to establish a known reference position (e.g., a “home” or “zero” position) at startup or during calibration. By way of example, a magnetic sensor such as a reed switch (or Hall‑effect sensor) may be positioned to detect a magnet coupled to a moving arm or wrist component at a predetermined reference angle. During initialization, controller 204 actuates lift motor 214 and/or wrist motor 216 until the corresponding reference sensor is triggered, and may then set an internal position variable to a defined reference value for maneuverable arm 106 and/or manure collection implement 108. Such homing may improve repeatability of arm positioning, support closed‑loop control of lift and wrist angles, and provide a safety mechanism to avoid accumulating position error over repeated operational cycles.

In certain embodiments, animal cleanup machine 100 is configured to use a common motor type across multiple subsystems, such as across one or more traction motors 206 of drive train 122, lift motor 214 of maneuverable arm 106, and wrist motor 216 of rotatable manure collection implement 108 (or a rake attachment as described herein). Using a common motor type across subsystems may simplify assembly, reduce spare‑parts inventory, and improve maintainability, for example by allowing a user to stock a single replacement motor suitable for installation at multiple motor locations of animal cleanup machine 100. In such embodiments, one or more gear motors, brushed DC motors, brushless motors, or servomotors may be selected with output torque and speed characteristics sufficient for the most demanding of the subsystems, while being used in other subsystems with greater torque margin than required.

In certain embodiments, structural components of maneuverable arm 106 (including one or more tubular members, joints, and mounts) are selected and dimensioned based on engineering analysis to withstand expected static and dynamic loads during manure collection and transport. For example, the arm structure may be validated using finite element analysis (FEA) or other stress/strain analysis to confirm that stresses under a worst‑case payload and geometry remain below material yield limits with an engineering safety factor exceeding a predetermined design target. Such analysis may be performed using a simplified model of the arm (e.g., modeling one or more tubular members as cantilevered structures) and applying loads representing a payload at the distal end and moments corresponding to an estimated payload center of mass, thereby providing a conservative validation of arm strength for the intended operating conditions.

### Battery and Power System Concepts

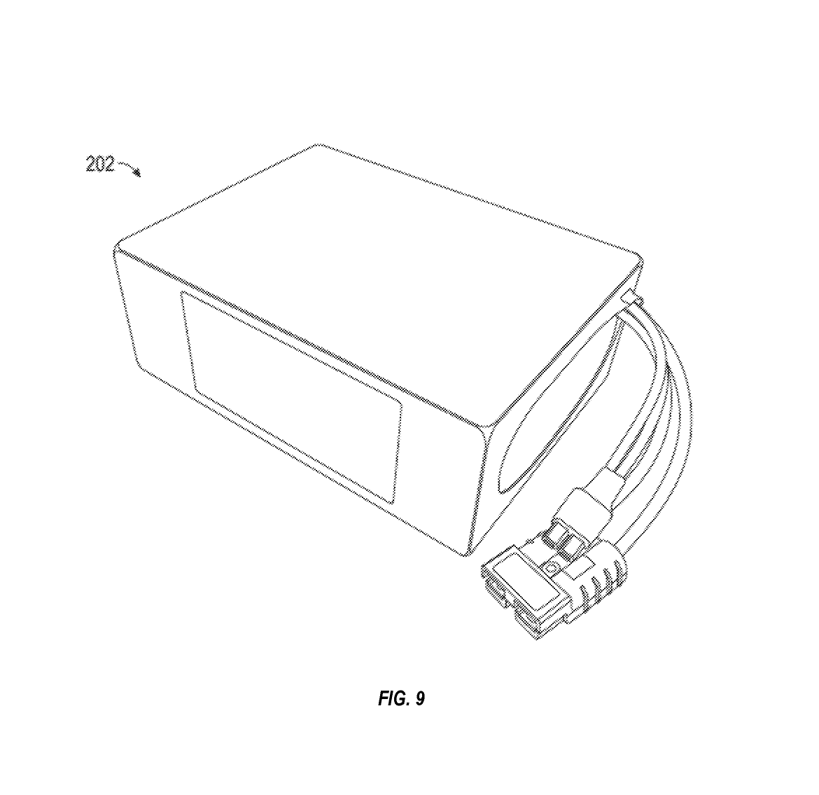

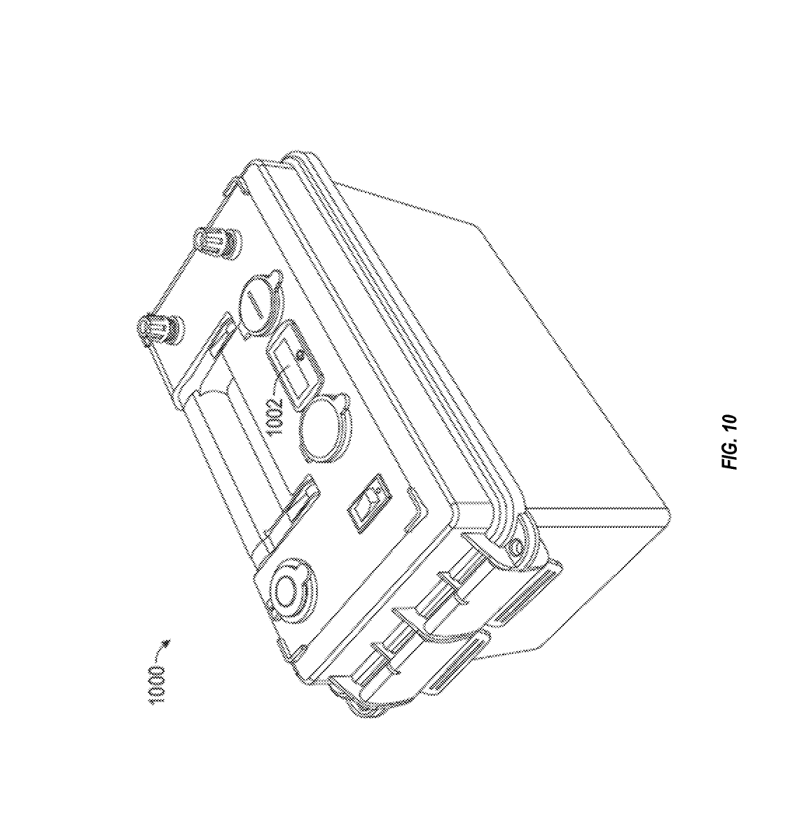

FIG. 9 is a perspective view illustrating one example rechargeable battery 202 of FIG. 2, in embodiments. FIG. 10 is a perspective view illustrating one example power box 1000 for containing rechargeable battery 202 of FIGS. 2 and 9. Power box 1000 may represent power box 110 of FIG. 1. Battery 202 is selected to provide all electrical power to hardware and mechanical sub-systems of animal cleanup machine 100 with an operating time at least one hour and up to two hours while minimizing weight. In the example of FIG. 9, rechargeable battery 202 is a 12V 40 amp-hour Bioenno battery. Power use by non-drive systems was estimated at 60WH and power for drive train 122 and controller 204 was estimated at 300 WH. Assuming a robot weight of 60 lbs. and a target speed of 5 mph, power was estimated at 290 WH for drive train 122 to provide sufficient maneuverability of animal cleanup machine 100. Rechargeable battery 202 may be of other sizes to provide other operating durations without departing from the scope hereof. In one example, rechargeable battery 202 is a 12V 54 amp-hour battery. The 12V 40 amp-hour Bioenno battery was selected for its compatibility with power box 1000, which allows for easier battery removal and monitoring via a built-in display 1002. Power box 1000 also provides a waterproof enclosure for rechargeable battery 202 thereby reducing the risk of environmental damage to rechargeable battery 202. In certain embodiments, a power budget allocates on the order of about 246 W total draw at peak, corresponding to on the order of about 24 A at 12 V, such that a 12 V, 40 Ah battery provides a runtime on the order of about 1.65 hours under continuous peak draw and longer under typical duty‑cycled operation of the arm motors. In certain embodiments, the power box includes an on/off switch, user‑accessible connectors (e.g., power pole connectors), and an external display indicating remaining battery capacity. In certain embodiments, inline fuses or resettable breakers are placed in series with battery feeds to at least controller 204 and LiDAR 118 to limit overcurrent and reduce risk of damage in fault conditions.

### Software and Hardware Suite Concepts

The software and hardware suite subsystem of animal cleanup machine 100 consists of GNSS receiver 114, LiDAR 118, camera 116, and controller 204. Together, these components allow animal cleanup machine 100 to maneuver within environment 101 (e.g., an animal paddock), avoid obstacles, stay within a defined perimeter of environment 101, identify objects encountered within environment 101, and locate and move manure.

### GNSS Module

GNSS receiver 114 may be used to define parameters of environment 101 (e.g., a perimeter of the paddock and permanent obstacles such as trees, water stands, and troughs). GNSS receiver 114 may also be used to mark one or more drop off locations for animal cleanup machine 100 to deposit collected manure. For example, animal cleanup machine 100 may be manually controlled and/or carried to significant locations within environment 101 and software of controller 204 may receive inputs for recording and annotating the captured locations.

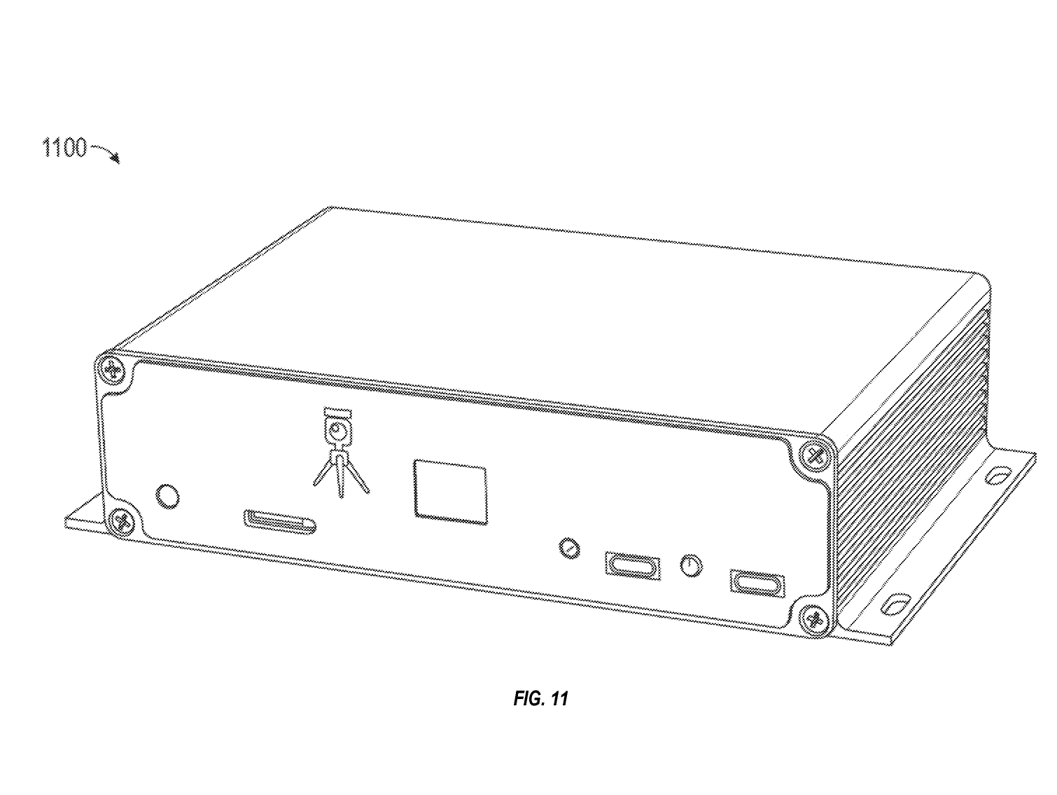

FIG. 11 is a perspective view illustrating one example GNSS base station 1100 that may be configured within environment 101 to allow GNSS receiver 114 to operate in a differential mode that is more accurate than operation without GNSS base station 1100. GNSS base station 1100 was included to increase accuracy of GNSS receiver 114 after learning that the fencing surrounding the paddock was difficult to detect using camera 116 and LiDAR 118. The combined use of GNSS base station 1100 with GNSS receiver 114 increased accuracy of determined locations within approximately 4 inches for example. Boundary definition may be performed by recording GNSS points while manually walking or driving animal cleanup machine 100 along a perimeter of environment 101 and then fitting a polygon or spline boundary in a local tangent plane coordinate system. GNSS base station 1100 provides differential corrections to achieve on the order of inches‑level accuracy, improving boundary compliance when fencing is not reliably detectable by onboard perception sensors.

### LiDAR

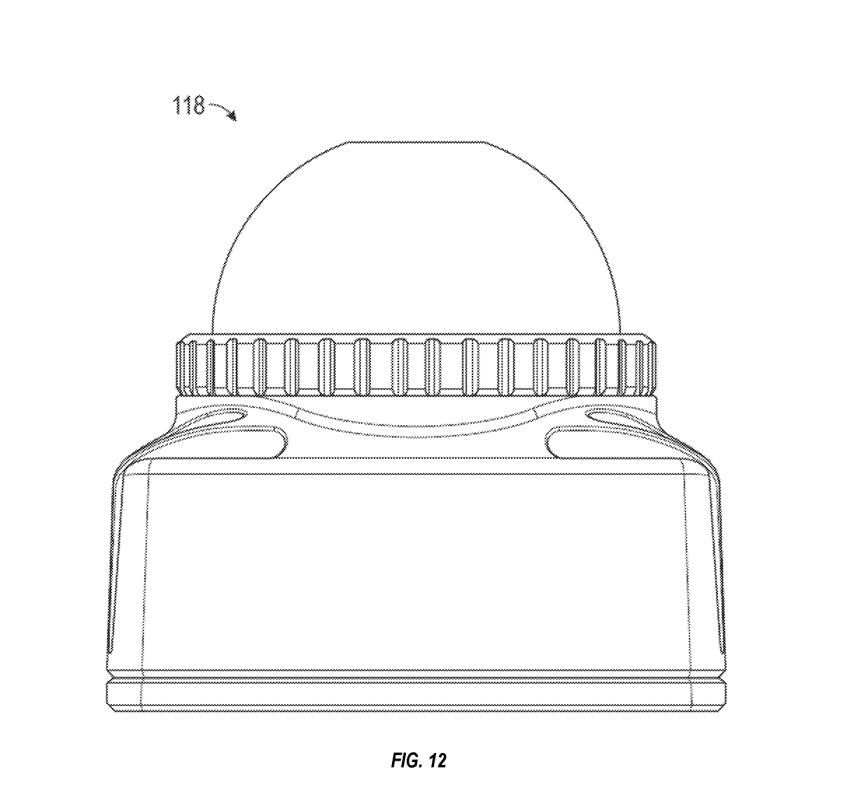

FIG. 12 is a perspective view illustrating one example of LiDAR 118 of FIGS. 1 and 2, in embodiments. LiDAR 118 is used to detect and identify dynamic obstacles, such as donkeys, volunteers, and movable objects like troughs and toys 342, within environment 101. LiDAR 118 allows animal cleanup machine 100 to navigate and respond in real-time to environment 101 with reduced risk of collision. LiDAR 118 continuously generates point cloud 332 that is a detailed, accurate, and three-dimensional mapping of environment 101 around animal cleanup machine 100. Point cloud 332 allows software 310 within controller 204 to comprehensively understand the surroundings of animal cleanup machine 100, including the precise location and movement of objects therein. For example, point cloud 332 allows software 310 to differentiate between stationary and moving objects, thereby enhancing the ability of animal cleanup machine 100 to avoid collisions and allows software 310 to make safety-critical decisions. By continuously scanning environment 101 and continuously feeding point cloud 332 to controller 204, LiDAR 118 ensures safe and efficient navigation of animal cleanup machine 100 even when environment 101 is dynamic and unpredictable.

### Camera

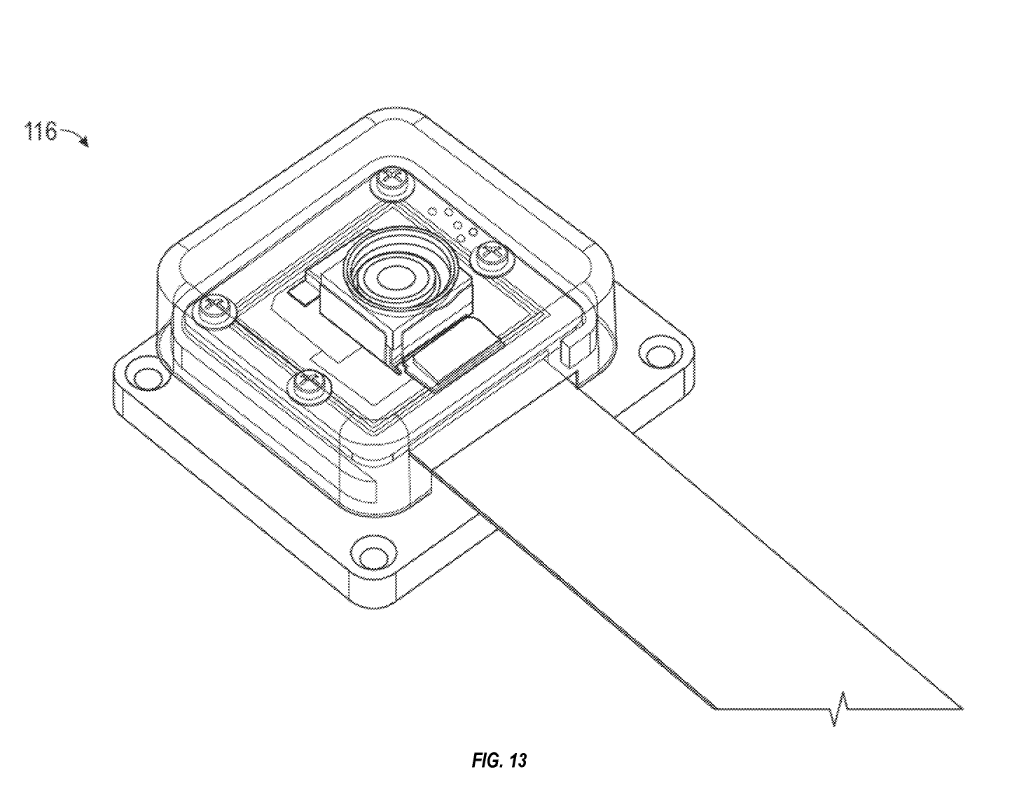

FIG. 13 is a perspective view illustrating one example of camera 116 of FIGS. 1 and 2, in embodiments. Camera 116 captures RGB images 330 (e.g., a video stream) that are processed by computer vision algorithm 308 to detect manure within environment 101. After detection, RGB images 330 are used with output from GNSS receiver 114 to define a location of the manure. Camera 116 may be housed in a water‑resistant enclosure and mounted with a known extrinsic calibration relative to the robot frame to support transformation of image detections into world coordinates.

### Controller

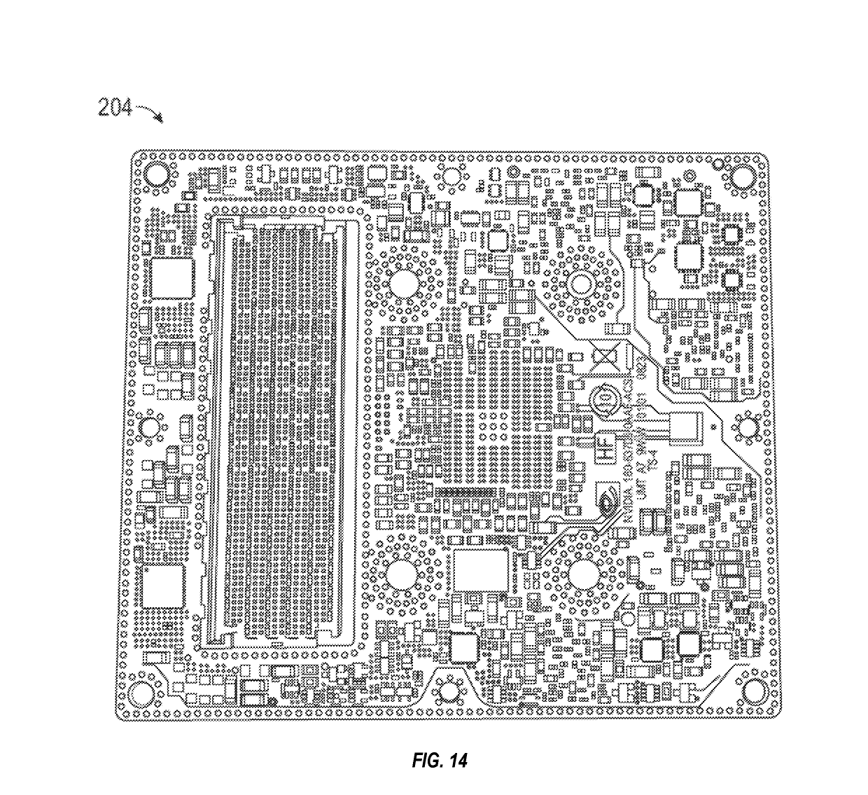

FIG. 14 is an image showing one example NVIDIA Jetson AGX Orin circuit board for implementing controller 204 of FIG. 2, in embodiments. Controller 204 is capable of embedded AI processing and includes software 310 for controlling all autonomous aspects of animal cleanup machine 100. Computer vision algorithm 308 is a machine learning algorithm for manure detection, for example, and navigator 312 implements a path finding algorithm that cooperates with an object avoider 316 to prevent animal cleanup machine 100 from colliding with static and moving objects of environment 101. Software 310 causes controller 204 to send control signals to traction motor 206, steering motor 212, lift motor 214, and wrist motor 216 to control physical movement of animal cleanup machine 100. In one example of operation, navigator 312 controls movement of animal cleanup machine 100 to position manure collection implement 108 at the determined location of the manure, and navigator 312 and arm controller 314 cooperate to collect (e.g., scoop up) the manure. Navigator 312 then controls animal cleanup machine 100 to move to a manure drop off location where arm controller 314 causes manure collection implement 108 to rotate and drop the manure.

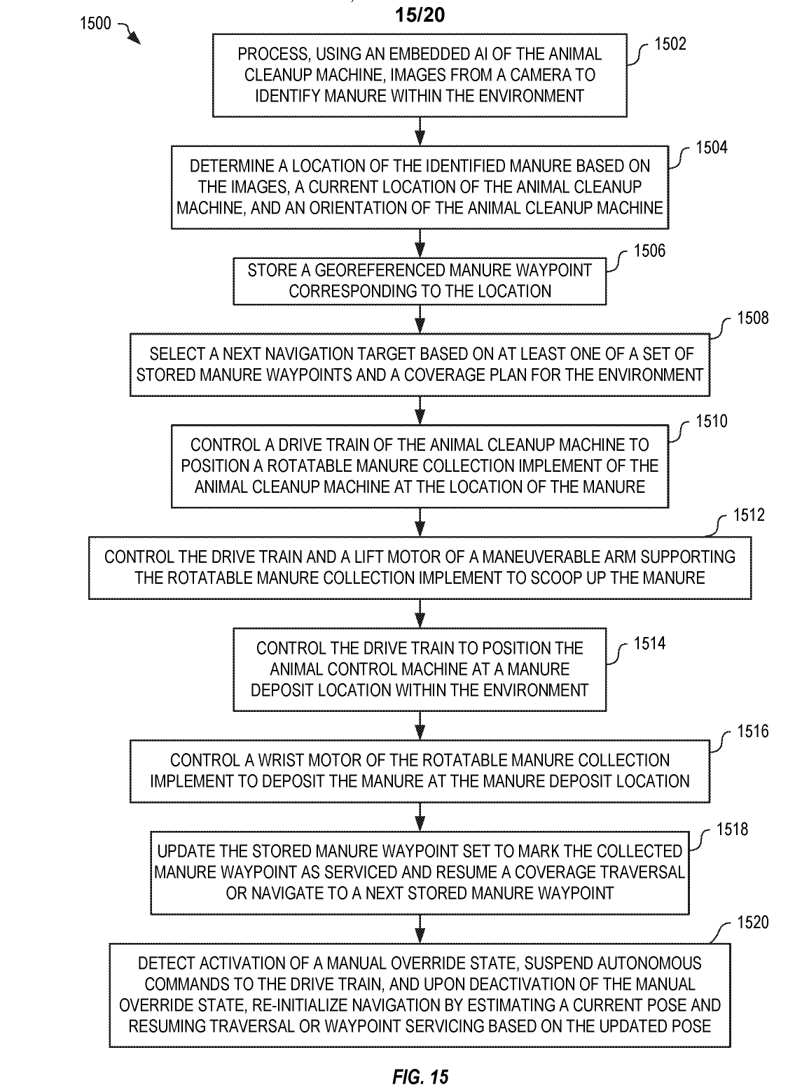

FIG. 15 is a flowchart illustrating one example method 1500 for controlling an animal cleanup machine to clean up manure in an environment, in embodiments. Method 1500 is implemented in software 310 of controller 204, for example.

In block 1502, method 1500 processes, using an embedded AI of the animal cleanup machine, images from a camera to identify manure within the environment. In one example of block 1502, computer vision algorithm 308 processes RGB image 330 to identify manure in environment 101. In block 1504, method 1500 determines a location of the identified manure based on the images, a current location determined by a GNSS receiver of the animal cleanup machine, and an orientation of the animal cleanup machine. In one example of block 1504, software 310 determines a location of the identified manure based on RGB image 330, a current location of animal cleanup machine 100 determined by GNSS receiver 114, and an orientation of animal cleanup machine 100.

In block 1506, method 1500 stores a georeferenced manure waypoint corresponding to the location. In one example of block 1506, controller 204 stores a determined location of manure 344 in memory 304 as manure waypoints 322.

In block 1508, method 1500 selects a next navigation target based on at least one of a set of stored manure waypoints and a coverage plan for the environment. In one example of block 1508, controller 204 invokes navigator 312 to determine a next waypoint for animal cleanup machine 100 based on map 320 and manure waypoints 322.

In block 1510, method 1500 controls a drive train of the animal cleanup machine to position a rotatable manure collection implement of the animal cleanup machine at the location of the manure. In one example of block 1510, controller 204 controls traction motor 206 and steering motor 212 to cause drive train 122 to maneuver animal cleanup machine 100 to position manure collection implement 108 at the location of the identified manure. In block 1512, method 1500 controls the drive train and a lift motor of a maneuverable arm supporting the rotatable manure collection implement to scoop up the manure. In one example of block 1512, controller 204 controls traction motor 206, steering motor 212, and lift motor 214 to scoop up the manure. In block 1514, method 1500 controls the drive train to position the animal cleanup machine at a manure deposit location within the environment. In one example of block 1514, controller 204 controls traction motor 206, steering motor 212 of drive train 122 to maneuver animal cleanup machine 100 to a defined manure deposit location within environment 101. In block 1516, method 1500 controls a wrist motor of the rotatable manure collection implement to deposit the manure at the manure deposit location. In one example of block 1516, controller 204 controls wrist motor 216 to rotate manure collection implement 108 to drop the manure at the manure deposit location of environment 101.

In block 1518, method 1500 updates the stored manure waypoint set to mark the collected manure waypoint as serviced and resumes a coverage traversal or navigates to a next stored manure waypoint.

In block 1520, method 1500 detects activation of a manual override state, suspends autonomous commands to the drive train, and upon deactivation of the manual override state, re-initializes navigation by estimating a current pose and resuming traversal or waypoint servicing based on the updated pose.

Steps 1502 through 1512 repeat to identify and move other manure to the manure deposit location within environment 101.

### Design Requirements

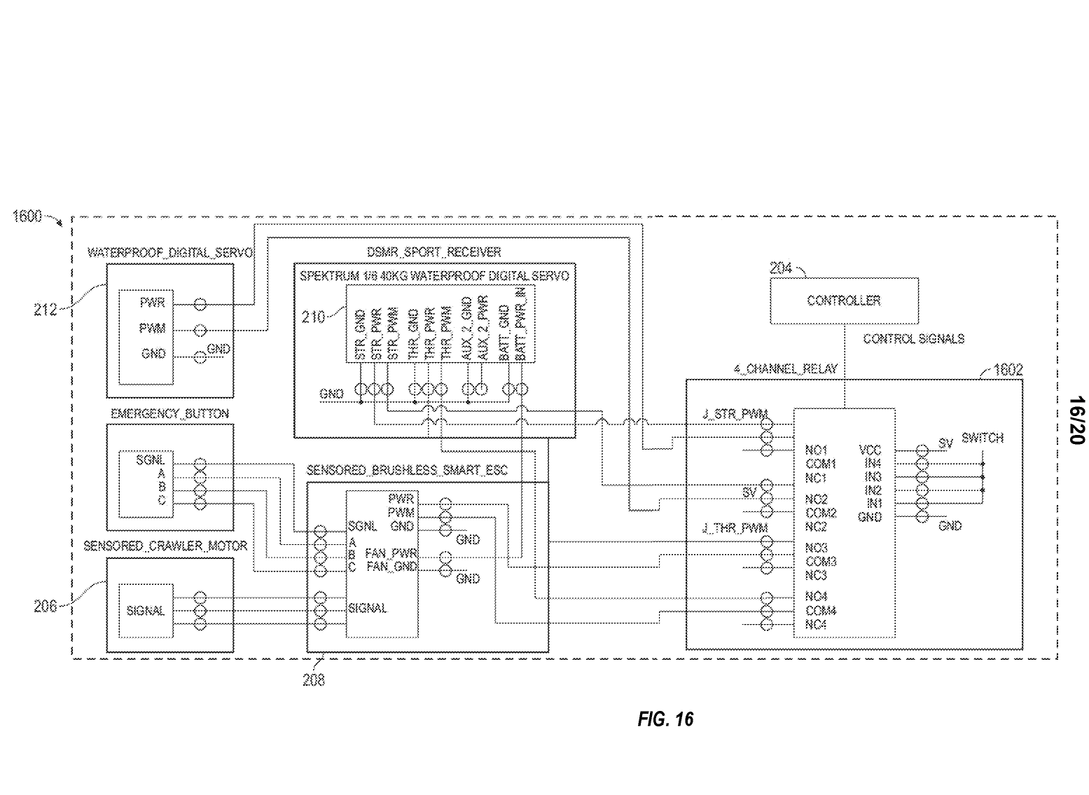

FIG. 16 is a wiring schematic illustrating one example manual override and control switching subsystem 1600 for animal cleanup machine 100 of FIG. 1, in embodiments. A multi‑channel relay 1602 electrically couples between controller 204 and receiver 210 that interfaces with drive train. Relay 1602 is configured to selectively couple control signals to ESC 208 and steering motor 212 from either (i) controller 204 operating in an autonomous mode or (ii) a handheld radio control receiver associated with a manual control device. In one example of operation, when relay 1602 is in a first state, pulse‑width‑modulated (PWM) or equivalent control signals generated by controller 204 are routed to ESC 208 and steering motor 212 to control traction motor 206 and steering motor 212 during autonomous operation. When relay 1602 is switched to a second state, control authority is transferred to receiver 210, allowing a user to manually maneuver animal cleanup machine 100. Relay 1602 may be actuated by a physical switch, a keyed switch, or a control signal generated by controller 204 in response to a detected fault condition. This configuration provides a fail‑safe mechanism that allows immediate manual control of animal cleanup machine 100 without disconnecting or re‑wiring system components.

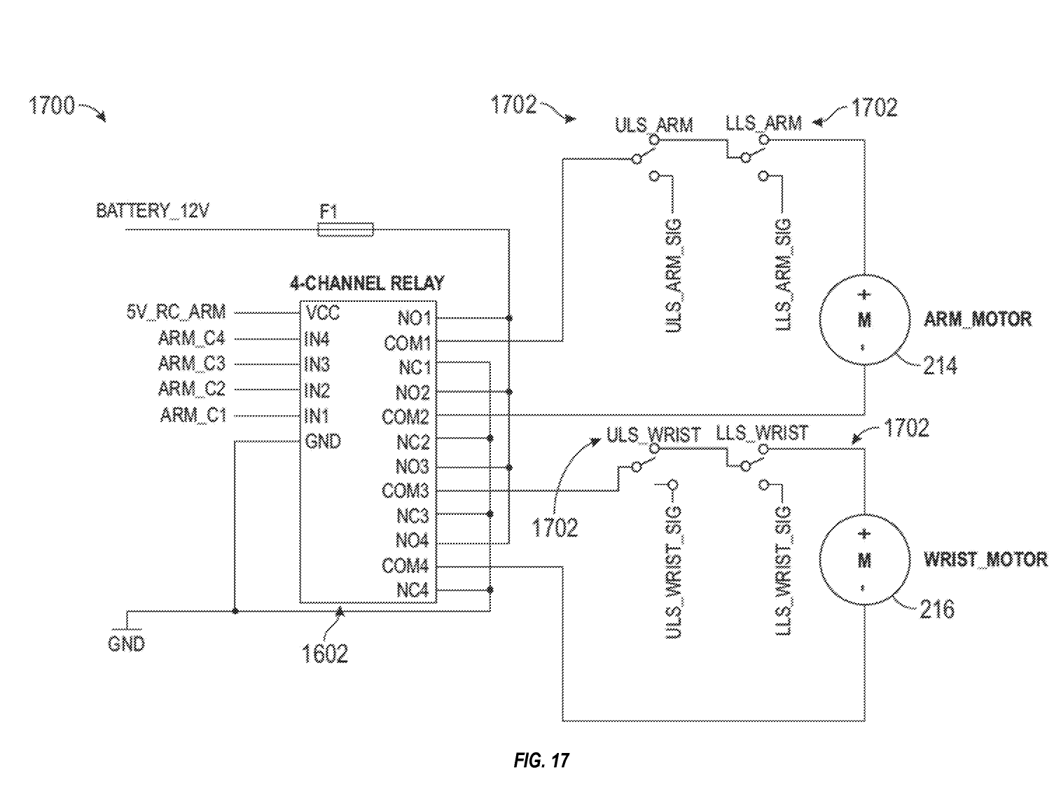

FIG. 17 is a wiring schematic illustrating one example arm motor control and limit switch feedback arrangement 1700 for maneuverable arm 106 of animal cleanup machine 100 of FIG. 1, in embodiments. Controller 204 is electrically coupled to lift motor 214 and wrist motor 216 via relay 1602 that controls direction and activation of the respective motors. One or more limit switches 1702 are positioned along the range of motion of maneuverable arm 106 and manure collection implement 108 and are electrically coupled in series with the motor control circuit and/or as feedback inputs to controller 204. In operation, actuation of a limit switch 1702 interrupts motor power and/or provides a signal to controller 204 indicating that a mechanical limit has been reached. This arrangement enforces motion limits independent of software and provides a mechanical fail‑safe to prevent over‑travel, excessive loading, or unintended motion of maneuverable arm 106 during autonomous or manual operation of animal cleanup machine 100.

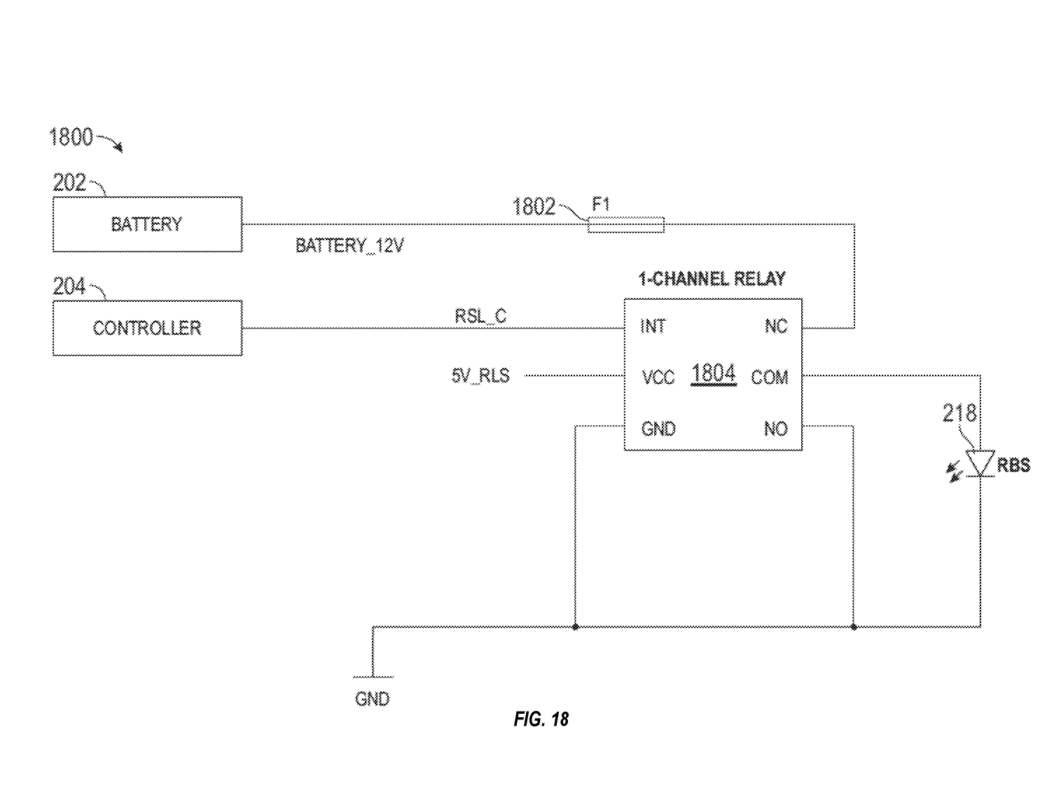

FIG. 18 is a schematic diagram illustrating one example control arrangement 1800 for robot signal light 218 of animal cleanup machine 100 of FIG. 1, in embodiments. Robot signal light 218 is electrically coupled to battery 202 through an inline overcurrent protection device 1802 and a relay 1804 (or driver circuit) controlled by controller 204. Controller 204 selectively actuates relay 1804 using one or more general‑purpose input/output (GPIO) lines or pulse‑width‑modulated control signals to energize robot signal light 218 according to predefined operating states. For example, controller 204 may cause robot signal light 218 to emit different illumination patterns corresponding to autonomous operation, manual override, low battery condition, fault detection, or idle state. By providing a visible indication of operational status, robot signal light 218 enhances situational awareness for users and bystanders during operation of animal cleanup machine 100 in an outdoor environment.

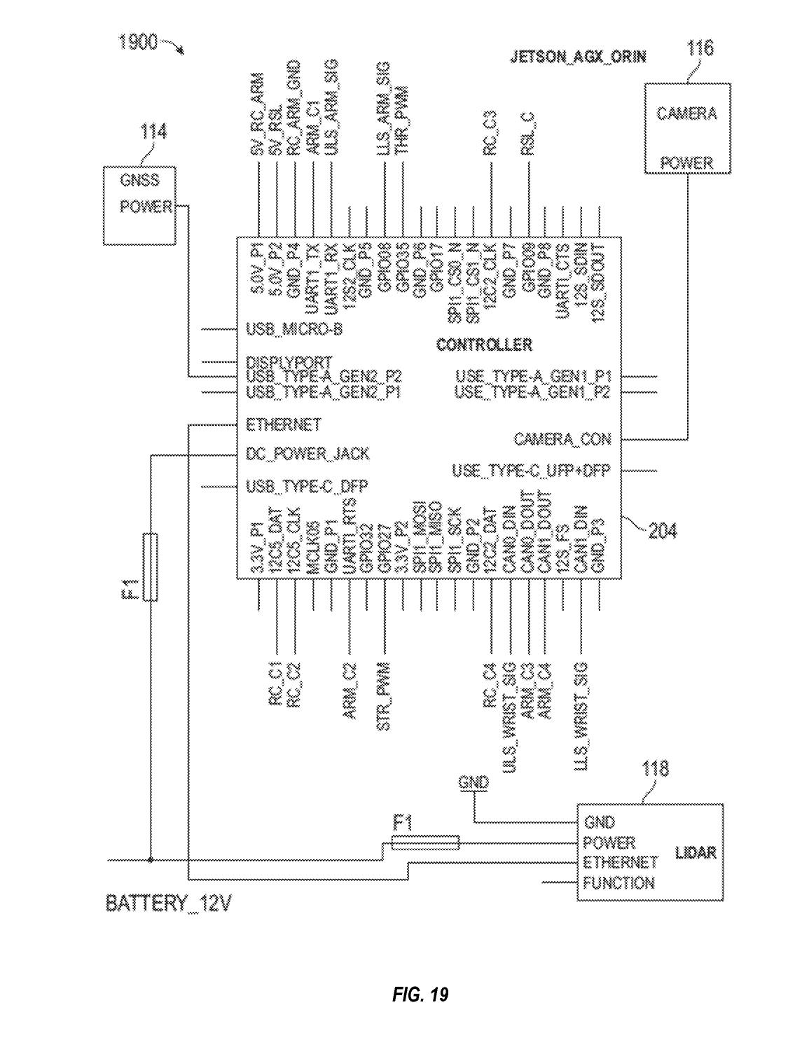

FIG. 19 is a block diagram illustrating one example processing pipeline 1900 for generating georeferenced manure waypoints within environment 101 of animal cleanup machine 100. In the illustrated embodiment, camera 116 provides RGB images to computer vision algorithm 308 executed by controller 204. Computer vision algorithm 308 identifies manure within the images and outputs image‑plane location data associated with the detected manure. LiDAR 118 provides point cloud data corresponding to objects within environment 101, which may be correlated with the image‑plane location to estimate a spatial position of the manure relative to animal cleanup machine 100. Controller 204 further receives a current location of animal cleanup machine 100 from GNSS receiver 114 and an orientation estimate derived from GNSS heading, inertial sensing, wheel odometry, or a combination thereof. Using these inputs, controller 204 transforms the estimated manure position into a map coordinate frame and stores the resulting georeferenced location as manure waypoints 322 in memory 304. Manure waypoints 322 may then be used by navigator 312 to control drive train 122 and maneuverable arm 106 to collect the manure and transport it to a designated manure deposit location within environment 101. This pipeline enables repeated detection, storage, and servicing of multiple manure locations during autonomous traversal of the environment.

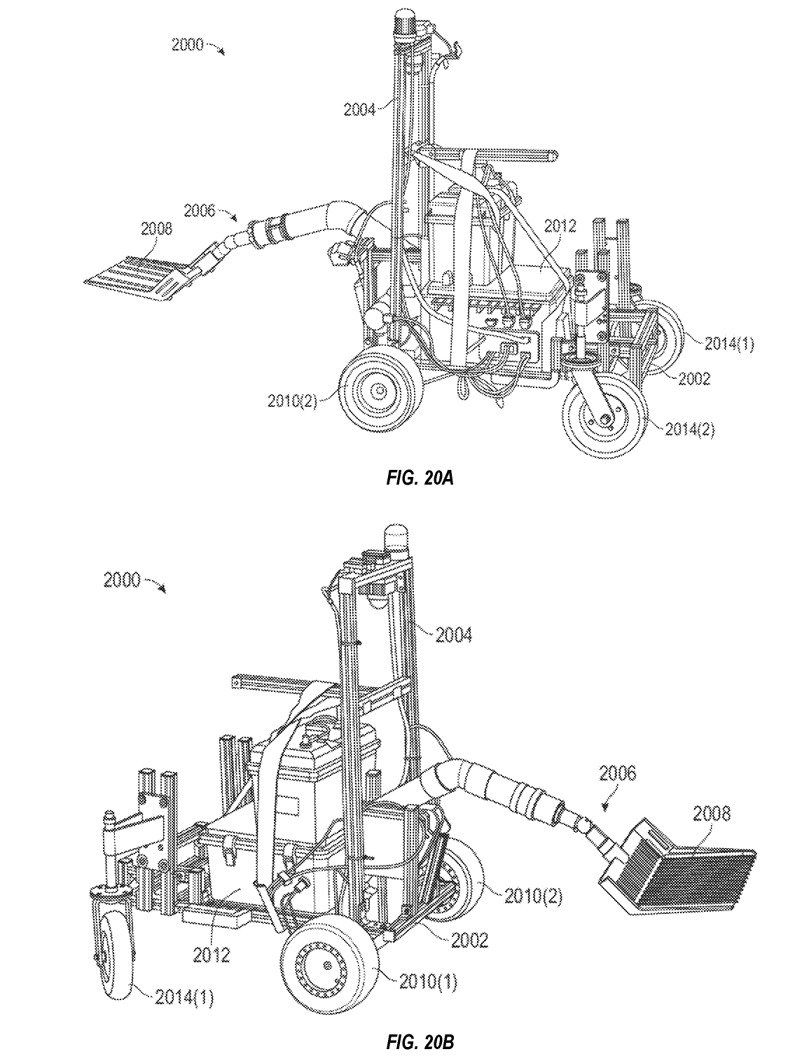

FIGS. 20A and 20B illustrate different perspectives of one example embodiment of an animal cleanup machine 2000 that implements differential steering using two traction motors, in embodiments. Animal cleanup machine 2000 is similar to animal cleanup machine 100 and includes a chassis 2002 supporting a vertically oriented control mast/frame 2004, a weatherproof control box 2012, and a maneuverable arm 2006 terminating in a manure‑collection implement 2008, such as a rake or shovel. A pair of ground‑engaging drive wheels 2010 (e.g., drive wheel 2010(1) and 2010(2)) are independently driven by respective traction motors (e.g., similar to traction motor 206) positioned on opposite lateral sides of chassis 2002. Controller circuitry within weatherproof control box 2012 is configured to independently control the rotational speed and direction of each drive wheel 2010, thereby enabling differential steering. As a result, animal cleanup machine 2000 may execute curved turns, pivot turns, and zero‑radius turns by commanding the ground-engaging drive wheels 2010 to rotate at different speeds or in opposite directions. Rear wheels 2014 (e.g., rear wheels 2014(1) and 2014(2)) of animal cleanup machine 2000 are mounted as caster‑type wheels, each being rotatably mounted about a generally vertical axis such that the rear wheels are free to swivel relative to the chassis. This caster mounting allows rear wheels 2014 to automatically align with the direction of travel during differential steering by the traction motors, thereby reducing scrubbing, improving maneuverability, and facilitating smooth turning and pivoting motions of the machine. Advantageously, the differential steering configuration allows animal cleanup machine 2000 to reorient chassis 2002 and maneuverable arm 2006 relative to environment 101 without requiring a separate steering linkage. This differential steering arrangement improves maneuverability in confined paddock environments and allows precise positioning of manure-collection implement 2008 relative to detected manure locations.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An animal cleanup machine, comprising:
a mobile chassis including a drive train configured to move the machine within an animal enclosure;
a maneuverable arm supported by the chassis and having a manure collection implement;
a camera configured to capture images of an environment ahead of the machine;
a locating device configured to determine a current location of the machine;
a controller including at least one processor and memory storing machine‑readable instructions, the controller configured to:
process the images using a computer vision model to detect animal manure within the images;
determine a georeferenced location of the detected animal manure based on (i) an image‑plane location of the detected animal manure, (ii) the current location from the locating device, and (iii) an orientation estimate of the machine;
control the drive train to position the machine at the georeferenced location of the detected animal manure; and
control the maneuverable arm to collect the detected animal manure and transport the collected animal manure to a predefined manure deposit location within the enclosure.

2. The animal cleanup machine of claim 1, wherein the controller is further configured to store the georeferenced location of the detected animal manure as a waypoint in memory and to schedule collection of the animal manure based on a coverage plan.

3. The animal cleanup machine of claim 1, wherein determining the georeferenced location further comprises estimating a range to the detected animal manure using depth information derived from at least one of a LiDAR point cloud, stereo disparity, monocular depth inference, and ground‑plane projection.

4. The animal cleanup machine of claim 1, further comprising a LiDAR sensor configured to generate a point cloud used by the controller to detect obstacles within the enclosure, wherein the controller is configured to avoid collisions by modifying a planned path in response to obstacles detected using the LiDAR sensor.

5. The animal cleanup machine of claim 1, wherein the controller is configured to enforce boundary compliance by comparing a current pose of the animal cleanup machine to a predefined boundary stored as a polygon.

6. The animal cleanup machine of claim 1, wherein the locating device comprises a global navigation satellite system (GNSS) receiver configured to operate in a differential mode using a GNSS base station to improve positional accuracy.

7. The animal cleanup machine of claim 1, wherein the maneuverable arm includes a lift motor and a wrist motor configured to rotate the manure collection implement to deposit collected animal manure.

8. The animal cleanup machine of claim 7, wherein one or both of the lift motor and the wrist motor is coupled to at least one limit switch configured to prevent over‑travel of the maneuverable arm.

9. The animal cleanup machine of claim 1, wherein the manure collection implement comprises at least one of a shovel, fork, and a rake removably coupled to the maneuverable arm.

10. The animal cleanup machine of claim 1, wherein the controller includes an embedded graphics processing unit configured to execute the computer vision model.

11. The animal cleanup machine of claim 1, further comprising a manual override subsystem configured to selectively switch control of the drive train between the controller and a remote operator input device.

12. The animal cleanup machine of claim 1, wherein the controller is configured to disable one or more motors in response to a detected fault condition.

13. A method of autonomously collecting animal manure, comprising:
capturing images of an outdoor animal enclosure using a camera mounted on a mobile animal cleanup machine;
processing the images using a computer vision model executed by a controller of the machine to detect animal manure;
determining a georeferenced location of the detected animal manure based on the images, a location of the machine, and an orientation of the machine;
controlling a drive train of the machine to move the machine to the georeferenced location;
actuating a maneuverable arm to collect the detected animal manure; and
transporting the collected animal manure to a predefined manure deposit location.

14. The method of claim 13, further comprising storing the georeferenced location as a waypoint and scheduling collection based on a coverage strategy.

15. The method of claim 13, wherein determining the georeferenced location includes estimating a range to the detected animal manure using depth information derived from a LiDAR sensor.

16. The method of claim 13, further comprising enforcing a boundary of the enclosure by preventing the machine from exiting a predefined polygon.

17. A non‑transitory computer‑readable medium storing instructions that, when executed by one or more processors of a mobile robotic animal cleanup machine, cause the mobile robotic animal cleanup machine to:
process image data from a camera using a trained vision model to detect animal manure;
determine a georeferenced manure location using the detected animal manure, position data, orientation data, and range data from a ranging sensor;
control a drive train to navigate to the georeferenced manure location;
control a maneuverable arm to collect the animal manure; and
control the drive train and maneuverable arm to transport and deposit the animal manure at a predefined deposit location.

18. The non‑transitory computer‑readable medium of claim 17, wherein the instructions cause sensor‑fusion of global navigation satellite system (GNSS) receiver data, inertial, and wheel‑encoder measurements to estimate a pose of the mobile robotic animal cleanup machine.

19. The non‑transitory computer‑readable medium of claim 17, wherein the instructions cause detected manure locations to be queued and collected according to a nearest‑neighbor or prioritized scheduling algorithm.

20. The non‑transitory computer‑readable medium of claim 17, wherein the instructions further cause motor controllers to be placed in a safe state upon detection of a fault.
